(19) United States
(12) Patent Application Publication
(10) Pub. No.: US 2024/0309024 A1
(43) Pub. Date: Sep. 19, 2024

(54) DIRECT SYNTHESIS OF ALKENYLHALOSILANES

(71) Applicant: Momentive Performance Materials Inc., Niskayuna, NY (US)

(72) Inventors: Kenrick Martin Lewis, Flushing, NY (US); Yanjun Zhu, Rye Brook, NY (US); Christopher M. Byrne, Gibsonia, PA (US)

(21) Appl. No.: 18/598,241

(22) Filed: Mar. 7, 2024

Related U.S. Application Data
(60) Provisional application No. 63/452,038, filed on Mar. 14, 2023.

(51) Int. Cl. C07F 7/16

(52) U.S. Cl. CPC C07F 7/16

(57) ABSTRACT

A process for the direct synthesis of alkenylhalosilane monomers. Forming a slurry of liquid and copper-activated silicon from fresh silicon, cyclone fines and/or fine dust from silicon grinding, ultrafines and/or spent contact mass from the Direct Synthesis of alkylhalosilanes and arylhalosilanes, in a thermally stable solvent. Reacting the silanes by agitating the slurry with at least one unsaturated aliphatic or cycloaliphatic organohalide of the formula R¹X, and optionally an organohalosilane and/or hydrogen halide, in the presence of a polymerization inhibiting Lewis base additive, at a reaction time, temperature and pressure effective to produce alkenylhalosilanes having the formulae, R¹SiHX₂, R¹₂SiHX, R¹₃SiX, R¹SiX₃, and R¹₂SiX₂ or mixtures thereof.

### CROSS REFERENCE TO RELATED APPLICATIONS

This application claims the benefit of and priority to Provisional application Ser. No. 63/452,038, filed Mar. 14, 2023, the entire contents of which are incorporated herein by reference.

### FIELD OF THE INVENTION

The invention relates to the synthesis, especially the slurry-phase Direct Synthesis of alkenylhalosilanes from silicon powders, especially copper-activated silicon reaction residues and byproducts. Such silicon source includes the silicon-containing solid residues generated during the Direct Synthesis of organohalosilanes from organohalides.

### BACKGROUND OF THE INVENTION

Allylhalosilanes are useful intermediates for the synthesis of organic specialties as well as for the synthesis of sulfur-silanes useful in tire and rubber applications (see U.S. Pat. Nos. 3,890,213; 8,003,724; 8,349,940; 8,536,261). A particularly valuable intermediate is allyltrichlorosilane, which can be converted to allyltriethoxysilane for the synthesis of sulfur-containing silanes. Use of diallyldiethoxysilane to prepare polyester—glass fiber laminates is disclosed in U.S. Pat. Nos. 2,563,288 and 2,649,396. Polymerization of the products can occur during the Direct Synthesis of allylchlorosilanes and other alkenylhalosilanes, Accordingly, the reactions are typically unstable and monomer yields are typically low.

Conventional methods of synthesis of allylsilanes include the Grignard Reaction (see for example, T. K. Sarkar, Science of Synthesis vol 4 (2002) 837-922) and dehydrohalogenation of halopropylsilanes (see for example Bailey, D. L.; Pines, A. N. Ind. Eng. Chem., 1954, 46, 2363).

Hurd (J. Amer. Chem. Soc., 67(1945) 1813; U.S. Pat. No. 2,420,912) reported the fixed-bed Direct Reaction of allyl chloride with copper-silicon alloys at 200-400° C., optimally 230-300°° C. The product mixture contained allyldichlorosilane (ADCS, C₃H₅SiHCl₂) diallyldichlorosilane (DADCS, (C₃H₅)₂SiCl₂) and allyltrichlorosilane (ATCS, C₃H₅SiCl₃), the latter being most.

U.S. Pat. No. 2,904,574 discloses the Direct Synthesis of allylchlorosilanes via fixed-bed reaction of allyl chloride with silicon coated with Cu₂S (copper (I) sulfide), at 150-220° C. The examples illustrated product mixtures containing 1-5 weight percent allyldichlorosilane (ADCS, C₃H₅SiHCl₂), 13-16 weight percent allyltrichlorosilane (ATCS, C₃H₅SiCl₃) and 11-24 weight percent diallyldichlorosilane (DADCS, (C₃H₅)₂SiCl₂) in addition to unconverted allyl chloride and 30-50 weight percent undistillable high boiling residue.

U.S. Pat. No. 5,338,876 discloses the Direct Synthesis of allylchlorosilanes in stirred-bed and fluidized-bed reactors at 220-350° C. and 1-5 atmospheres, preferably 300-330° C. and 1-3 atmospheres. The disclosure is particularly directed to the Direct Synthesis of allyldichlorosilane (ADCS) by reacting fresh silicon metal with mixtures of allyl chloride (AC) and hydrogen chloride, wherein the hydrogen chloride is in molar excess. A companion journal publication with this information is Yeon, et al (Organometallics, vol 12 (1993), pp 4887-4891). Other references to the Direct Synthesis of allylhalosilanes, as well as other alkenylhalosilanes, in fixed, stirred or fluidized bed reactors with fresh silicon metal are the following: R. J. H. Voorhoeve, Organohalosilanes: Precursors to Silicones, page 203-204; Petrov, et al., Synthesis of Organosilicon Monomers, pp 44-46 and in Table 5, page 55.

Hurd (supra) noted the rapid polymerization of diallyl dichlorosilane when it was heated above 150° C. in the absence of a polymerization inhibitor. However, there was no teaching on how to control or obviate polymerization during the Direct Synthesis to realize reaction stability. The polymerization of diallylsubstrates, including diallyldimethylsilane, is reported in the following: Forbes, et al., J. Amer. Chem. Soc., vol 114 (1992) pp 10978-10980; Marvel, et al., J. Org. Chem., vol. 25 (1960) pp 1161-1642; Butler, et al., J. Org. Chem., vol. 25 (1960) pp 1643-1644.

Alkylhalosilanes and arylhalosilanes are valuable precursors to silicones and organofunctional silanes that are used in a broad range of industries. Methylchlorosilanes and phenylchlorosilanes are particularly valuable and are the most commonly manufactured products of these classes. Manufacture is typically done using the Rochow-Müller Direct Process (also called Direct Synthesis and Direct Reaction), in which copper-activated silicon is reacted with the corresponding organohalide in a gas-solid or slurry-phase reactor at a temperature and pressure sufficient to effect the desired reaction rate and stability, and product selectivity and yield. Fluidized-bed reactors are the gas-solid reactors most often used.

Organohalosilanes have the general formula, R¹ₐSiX_{b}, wherein R¹ is a saturated or unsaturated aromatic group, a saturated or unsaturated aliphatic group, alkaryl group, or cycloaliphatic hydrocarbyl group such as methyl, ethyl or phenyl, X is a halogen atom such as chlorine or bromine and a and b are positive integers with the proviso that the sum, (a+b)=4.

Organohalohydrosilanes have the general formula, R¹_{c}SiH_{d}Xₑ, in which R¹ and X have the same meaning as above. The subscripts, c, d and e are positive integers satisfying the sum, (c+d+e=4).

In the halosilanes, (H_{f}SiX_{g}), f≥0 and g is an integer such that (f+g=4). X is a halogen atom as defined above.

Organohalodisilanes contain one Si—Si bond as indicated in the general formula, (R¹ₕXⱼSiSiXₖR¹₁). R¹ and X have the same meanings as defined above. The subscripts, h, j, k and l are individually≥0 with the sums (h+j=3) and (k+l=3). By extension, trisilanes contain Si—Si—Si units and polysilanes have more than three catenated Si atoms.

Typically, silicon used in the Direct Process (Rochow-Müller Direct Process) is chemical grade with a pure silicon content of 98.5-99.5 weight percent. (All percentages herein will be by weight, unless indicated otherwise) This silicon can be produced by any of the methods in current practice, such as casting, water granulation, atomization and acid leaching. These methods are more fully described in Silicon for the Chemical Industry, (H. Oye, et al, Editors), vol I (pp 39-52), vol II (pp 55-80), vol. III (pp33-56, 87-94), Tapir Publishers, Norwegian Institute of Technology, and in U.S. Pat. Nos. 5,258,053; 5,015,751; 5,094,832; 5,128,116; and 4,539,194.

Hot effluent exiting from the fluidized-bed reactor, in which copper-activated silicon is undergoing reaction with an organohalide, typically comprises a mixture of copper, metal halides, silicon, silicides, carbon, gaseous organohalide, organohalosilanes, organohalodisilanes, carbosilanes and hydrocarbons. This mixture is generally first subjected to gas-solid separation in cyclones and filters (see U.S. Pat. No. 4,328,353). The gaseous mixture and ultrafine solids are condensed in a settler or sludge tank from which the organohalide, organohalosilanes, hydrocarbons and a portion of organohalodisilanes and carbosilanes are evaporated and sent to fractional distillation. The ultrafine solids will generally accumulate in the settler along with the less volatile silicon-containing compounds and this mixture (sludge) is typically purged periodically and sent to waste disposal or to secondary treatment for the recovery of monomers from the liquid fraction.

Three silicon-containing solid wastes are generally produced from the fluidized-bed. (1) Elutriated solids, which are trapped by the cyclone or filters, are called cyclone fines or cyclone solids; (2) Those particulates which escape the cyclones and collect in the settler are called ultrafines, settler solids or revaporizer solids; and (3) The solids, which remain unreacted in the fluidized-bed at the end of a campaign. This is called spent mass or spent contact mass. Typically, spent mass has a larger average particle size and wider particle size distribution than cyclone solids. Cyclone solids are typically larger than ultrafines. Spent mass and cyclone fines are dry solids, which can be pyrophoric. Ultrafines are typically wet and agglomerate into a sludge. For this reason, ultrafines are sometimes called sludge.

A world-class methylchlorosilane plant will generally produce and therefore need to dispose of thousands of tons of ultrafines, cyclone solids and spent mass per year at considerable cost and loss of raw material value. There are also environmental impacts of the waste disposal methods employed. Accordingly, it is desirable to recover value from these waste solids. Methods of reusing the solids for copper recovery, for production of chlorosilanes, alkoxysilanes, methylchlorosilanes and phenylchlorosilanes have been disclosed in the patent and journal literature. However, the reactions can be unstable and monomer yields are typically low.

Passivation of cyclone solids for safe landfill disposal or later recovery of copper is disclosed in U.S. Pat. No. 5,342,430.

U.S. Pat. No. 2,803,521 discloses a method to separate and recover silicon and copper from spent reaction masses. Soucek, et al., (Chem. Abstr. vol. 64 (1966) 17638c) and Kopylov, et al., (Chem. Abstr. vol 75 (1971) 14421g) disclose metallurgical processes for copper recovery from roasted spent masses.

Rathousky, et al. (Chem. Abstr. vol 81(1974) 78008) reported the Direct Synthesis of phenylchlorosilanes using spent mass from the Direct Synthesis of methylchlorosilanes. Takami, et al (Chem. Abstr., vol 89(1978) 509946) disclosed a similar Direct Synthesis of phenylchlorosilanes from methylchlorosilane spent mass that was first heated to 500-900° C.

Ritzer, et al (U.S. Pat. No. 4,390,510) and others have shown that reaction of cyclone fines with HCl produces trichlorosilane and silicon tetrachloride. Reaction of cyclone fines with alcohols produces alkoxysilanes. These uses of cyclone solids are cited in Catalyzed Direct Reactions of Silicon, K. M. Lewis and D. G. Rethwisch (Editors), Elsevier, NY 1993, pages 28-29 and refs cited therein.

U.S. Pat. No. 5,712,405 discloses the collection of cyclone fines and filtered fines and recycling them to the bottom of the fluidized bed reactor for further reaction with an organohalide to produce organohalosilanes.

U.S. Pat. No. 6,465,674 discloses introducing cyclone fines into liquid silanes and reinjection of that suspension into the fluidized bed for Direct Synthesis of chloro or organocholorosilanes.

U.S. Pat. No. 4,224,297 discloses a method for the reuse of spent mass with a maximum particle size of 50 microns comprising heating it at 100-350° C. in air or nitrogen for at least 15 hours prior to reacting it with methyl chloride to produce methylchlorosilane monomers. This particle size distribution is too small for most conventional Rochow-Müller fluidized bed reactors.

The foregoing references describing the synthesis of organohalosilanes from cyclone fines and spent mass comprise gas-solid reactions in two phase reactors. Those cited below are done in three-phase reactors, such as mechanically agitated slurry reactors and bubble columns employing all three phases of matter.

British Patent, GB 1,131,477 describes a process for the preparation of alkylhalo-silanes comprising suspending a contact mass composition in an inert liquid, such as a halogenated aromatic hydrocarbon, at a temperature greater than 175° C. and reacting it with an alkyl halide to produce alkylhalosilanes.

U.S. Pat. No. 7,153,991 discloses the slurry-phase Direct Synthesis of organohalosilanes comprising preparing a slurry of nanosized copper catalyst and silicon, 90 percent of which is between about 1 to about 300 microns, in a thermally stable organic solvent and followed by reaction with an organohalide at temperature greater than 250° C.

U.S. Pat. No. 9,249,165 discloses a catalytic slurry-phase Direct Synthesis of organohalosilanes from cyclone fines, wherein specific additives are used to forestall decomposition of the solvent. The figures depict conversions for dimethyldichlorosilane production. Said additives include solvent protecting additions of terpenes, hexamethyldisiloxane, diphenylamine and alpha-omega dialkylpolyethers.

All of the references cited in this specification (above and below) are incorporated herein by reference, in their entirety.

There have been many attempts in the past to recover value, particularly methylchlorosilane monomers from spent mass and cyclone solids produced during the Direct Synthesis of organohalosilanes, such as methylchlorosilanes. However, none of these attempts has resulted in a reliable process that produces a composition of highly valued alkenylhalosilanes in sufficient quantities.

It is desirable to develop improved methods of synthesizing alkenylhalosilanes that avoid the drawbacks of conventional methods.

### SUMMARY OF THE INVENTION

The present invention provides a stable, efficient, slurry-phase Direct Synthesis of alkenylhalosilanes, particularly allylhalosilanes from fresh copper-activated silicon, cyclone fines, spent mass, ultrafines, silicon dust from grinding, and the like, and mixtures thereof, providing improved product yields and efficiencies. This includes the synthesis of alkenylhalosilanes from the silicon-containing solid residues generated during the Direct Synthesis (Rochow-Müller Direct Process) of organohalosilanes, and the appropriate organohalide. In accordance with the present invention, certain additives exhibiting Lewis base properties are effective to forestall or inhibit undesirable side reactions, including polymerization of allylhalosilanes.

One embodiment of the invention provides a process for the synthesis of alkenylhalosilanes. The process comprises forming a slurry in a thermally stable solvent of copper-activated silicon from fresh silicon, cyclone fines, fine dust from silicon grinding, ultrafines and/or spent contact mass from the Direct Synthesis of organohalosilanes. This slurry is agitated and reacted with at least one unsaturated aliphatic or unsaturated cycloaliphatic organohalide of the formula R¹X, and optionally an organohalosilane and/or hydrogen halide.

In accordance with the invention, selected additives are added to inhibit or control undesirable side reactions and polymerization of desired monomers. These additives typically exhibit Lewis Base properties, which among other mechanisms, can coordinate or react with the Lewis acids or adsorb on free copper surfaces.

Reaction time, temperature and pressure are controlled to produce alkenylhalosilanes having the formulae, R¹SiHX₂, R¹₂SiHX, R¹₃SiX, R¹SiX₃, and R¹₂SiX₂ or mixtures thereof. R¹ is an unsaturated aliphatic or cycloalkenyl group, and X is a halogen. The alkenylhalosilanes or mixtures thereof can then be recovered from the solvent, or more reactant can be added.

In accordance with the invention, additives exhibiting Lewis base properties include selected sulfur-containing compounds. These preferably comprise aliphatic and/or aromatic mercaptans (thiols), aliphatic and aromatic thioethers, thiourea and aliphatic and aromatic thioureas, phenothiazine and thioesters.

In another aspect of the invention, the additive can be tetramethylurea and mixtures with hexamethyldisiloxane and mixtures thereof with one or more of the sulfur-containing additives.

Yet another aspect of the invention is directed to the selective slurry phase Direct Synthesis of allyltrihalosilanes, or mixtures of allyltrihalosilanes and allyldihalosilanes, from copper-activated silicon, including fresh silicon, grinding dust, cyclone fines, ultrafines and/or spent mass and allyl halides, in the presence of hydrogen halides and additives which are capable of inhibiting Lewis-Acid catalyzed polymerization of allylhalosilanes.

Thus, the invention enhances the stability of the slurry-phase Direct Synthesis. The invention also enables the stable slurry phase Direct Synthesis of allylchlorosilanes in acceptable yields from cyclone fines and/or fresh silicon.

### DETAILED DESCRIPTION OF THE PREFERRED EMBODIMENTS

The present invention relates to the production of monomers such as alkenylhalosilanes. A catalytic process is provided for converting processing byproducts, including fresh copper-activated silicon, as well as spent mass, cyclone fines and/or ultrafines from the Direct Synthesis of organohalosilanes, into more useful and potentially valuable products, such as alkenylhalosilanes. Preferred products include monomers of the following general formulae: R¹SiHX₂, R¹₂SiHX, R¹₂SiX₂, R¹₃SiX and R¹SiX₃ (and mixtures thereof). Particularly desirable monomers have the following general formulae: R¹SiHX₂ and R¹SiX₃. R¹ is preferably an unsaturated aliphatic or cycloalkenyl group, and X is a halogen atom.

Unless defined otherwise, all technical and scientific terms used herein will have the same meaning as commonly understood by one of ordinary skill in the art to which this invention belongs. Generally, the nomenclature used herein and the laboratory procedures described are well known and commonly employed in the art. Where a term is provided in the singular, the inventors also contemplate that the plural of that term is also applicable.

The expressions, “fresh silicon and fresh copper-activated silicon” refer to silicon and copper-activated silicon which have not previously been reacted with an organohalide or alcohol, but which might have already been reacted with a hydrogen halide.

“Direct Process,” “Direct Synthesis,” and “Direct Reaction” refer to a Eugene Rochow and Richard Müller process, the most common technology for preparing organosilicon compounds on an industrial scale. It involves the copper-catalyzed reaction of alkyl halides with silicon, and generally takes place in a chemical reactor, and in particular a fluidized bed reactor.

“Alkyl” herein refers to include straight, branched and cyclic alkyl groups. Specific and non-limiting examples of alkyls include, but are not limited to, methyl, ethyl, propyl and isobutyl.

“Substituted alkyl” berein refers to an alkyl group that contains one or more substituent groups that are inert under the process conditions to which the compound containing these groups is subjected. The substituent groups also do not substantially or deleteriously interfere with the process.

“Aryl” herein refers to a non-limiting group of any aromatic hydrocarbon from which one hydrogen atom has been removed. An aryl may have one or more aromatic rings, which may be fused, connected by single bonds or other groups. Specific and non-limiting examples of aryls include, but are not limited to, tolyl, xylyl, phenyl and naphthalenyl.

“Substituted aryl” herein refers to an aromatic group substituted as set forth in the above definition of “substituted alkyl.” Similar to an aryl, a substituted aryl may have one or more aromatic rings, which may be fused, connected by single bonds or other groups; however, when the substituted aryl has a heteroaromatic ring, the free valence in the substituted aryl group can be to a heteroatom (such as nitrogen) of the heteroaromatic ring instead of a carbon. If not otherwise stated, it is preferred that substituted aryl groups herein contain 1 to about 30 carbon atoms.

The invention can involve a three-phase catalytic process. The copper-activated silicon, spent mass, cyclone fines and/or ultrafines are suspended in a thermally stable liquid. They are then reacted with a gaseous alkenylhalide, in the presence of additives exhibiting Lewis base properties, which suppress side reactions and polymerization. Hydrogen halides can optionally be included. The desired organohalosilanes are then recovered. Temperatures, pressures, solvent/solid ratios, catalyst concentrations and reaction times can be adjusted to selected levels to effect the desired conversion into alkenylhalosilane monomers. This type of three-phase catalytic process can also be termed a slurry-phase process.

Preferred slurry-phase processes in accordance with the invention for the Direct Synthesis of alkenylhalosilane monomers from fresh copper-activated silicon, spent mass, cyclone solids and ultrafines, can provide silicon conversion of at least 40 weight percent and higher. The sum, (ATCS+ADCS), can be 40 wt. %, 60 weight percent and even higher, of the crude. Allyl chloride is the preferred reagent and gaseous HCl is preferably injected along with it.

Processes in accordance with the invention can be characterized by the additives, such as selected sulfur containing compound that suppress the side reactions. These can reduce or eliminate polymerization of the alkenylhalosilanes and enable both lower solvent/solid ratios and increased silicon conversion to produce the more highly valued alkenyl-halosilane monomers.

When the organohalide is an alkenyl halide (R¹X), the reaction products are typically R¹₂SiX₂, R¹²SiHX, R¹SiHX₂, R¹³SiX and R¹SiX₃, wherein R¹ is an alkenyl radical having 2 to 8 carbon atoms such as vinyl, allyl, methallyl or cyclohexenyl, and X is a halogen. When the organohalide is an allyl halide, the allyltrihalosilane and allyldihalosilane are both highly desirable.

Thus, the present invention provides a process for the synthesis of organohalosilane monomers of general formulae, R¹SiHX₂, R¹²SiHX, R¹³SIX, R¹SiX₃ and R¹²SiX₂, or mixtures thereof, by the reaction of fresh copper-activated silicon, spent mass, cyclone fines and ultrafines (such as those from the fluidized-bed Direct Synthesis of organohalosilanes) and mixtures thereof with an organohalide, RIX, in a three-phase reactor. R¹ is preferably an alkenyl radical having 2 to 8 carbon atoms and X is preferably a halogen atom such as fluorine, chlorine, bromine or iodine. Examples of R¹ include allyl, vinyl, methallyl and cyclohexenyl.

Preferred processes in accordance with the invention comprise the following steps:
(1) forming a slurry of a copper-activated silicon sourced from fresh silicon, cyclone fines, cyclone fine dust, silicon ultrafines and/or spent contact mass from the Direct Synthesis of organohalosilanes in a thermally stable solvent;
(2) agitating the slurry;
(3) reacting the agitated slurry with at least one unsaturated aliphatic or unsaturated cycloaliphatic organohalide of the formula R¹X, and optionally at least one organohalosilane or hydrogen halide in the presence of an additive exhibiting Lewis base properties, the additive effective to inhibit polymerization of the alkenylhalosilane, said reaction conducted for a reaction time, a reaction temperature, and a reaction pressure effective to produce the alkenylhalosilanes, said alkenylhalosilanes having the formulae, R¹SiHX₂, R¹₂SiHX, R¹₃SiX, R¹SiX₃, and R¹₂SiX₂ or mixtures thereof, wherein R¹ is an unsaturated aliphatic or cycloalkenyl group, and X is a halogen; and
(4) recovering the alkenylhalosilanes from the slurry.

In another embodiment, the process of the invention can also include the additional steps of:
(5) separating the solid reaction residue from the liquid and recovering the liquid for reuse in step (1); and/or
(6) passivating the solid for disposal or copper recovery.

The preference for alkenylhalosilanes of general formulae, R¹SiX₃ and R¹SiHX₂ can be expressed as the following gravimetric ratios:

(R¹SiX₃/R¹₂SiX₂),

(R¹SiHX₂+R¹SiX₃)/R¹₂SiX₂,

R¹SiX₃/(R¹₂SiX₂+R¹₃SiX+R¹SiHX₂+R¹₂SiHX) and

(R¹SiHX₂/+R¹SiX₃)/(R¹₂SiX₂+R¹₃SiX+R¹₂SiHX).

Each of these ratios is desirably greater than 1 and more preferably greater than 5. One reason for the desirability of R¹SiX₃ and R¹SiHX₂ is that they can be readily converted to alkenyl alkoxysilanes, such as allyltriethoxysilane, which have utility as organofunctional silane coupling agents.

Reaction rates can be reported as either the temporal consumption of silicon or alkenylhalide, or as the temporal formation of alkenylhalosilanes. Typical rate units include weight percent silicon conversion per hour, weight of crude alkenylhalosilanes produced per hour, or kilograms of alkenylhalosilanes per kilogram of silicon per hour. Stability can be considered the maintenance of desirable rate and selectivity until all raw materials are consumed, or consumed beyond a preset silicon conversion limit.

The alkenyl halide is introduced into the slurry as a gas, vapor, and/or liquid. Liquids can be fed, provided the flow rate is controlled to avoid large decreases in the reaction temperature and/or rapid expansion of bubbles formed during vaporization. Mixtures of alkenyl halides and mixtures of alkenyl halides with hydrogen halides can also be used. Mixtures of allyl halide and hydrogen halide afford increased formation of R¹SiHX₂ when cyclone fines are the source of copper-activated silicon. In accordance with preferred embodiments of the invention, it is advantageous that the molar ratio of allyl halide to hydrogen halide in the feed be greater than or equal to 0.8 to 1, and desirably in the range 1-100. This ratio is one of the variables influencing the relative amounts of R¹SiHX₂ and R¹SiX₃ in the reaction product. A value which affords the desired product composition can be established by experimentation.

As stated above, allylalkoxysilanes are important intermediates for the preparation of sulfur organofunctional silanes. Alkenylhalosilanes, R¹SiHX₂ and R¹SiX₃, produced by the instant process can be converted to alkenylalkoxysilanes via reaction with the appropriate alcohol. For example, allyldichlorosilane (ADCS) and allyltrichlorosilane (ATCS), individually or mixtures thereof, can be reacted with ethanol to form allyltriethoxysilane (Equations 1 and 2), as has been disclosed in U.S. Pat. No. 6,878,839. The efficient removal of hydrogen chloride or the presence of a hydrogen chloride acceptor is important for a high yield production of allyltriethoxysilane. In the absence of a hydrogen chloride acceptor, hydrogen chloride readily adds to the double bond in allyltriethoxysine (Equation 3), leading to the cleavage of C—Si bond, formation of by-products and resulting in the low yield of allyltriethoxysilane.

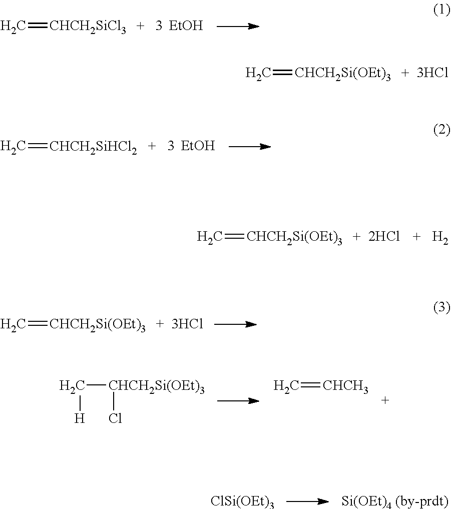

Tetraethoxysilane was generally the main product when sodium ethoxide was used as the HCl acceptor. With 1-methylimidazole, the hydrochloride formed a dense ionic liquid (see U.S. Pat. No. 7,351,339), which facilitated separation of allyltriethoxysilane. The yield was 87%. With poly(vinylpyridine) as the HCl acceptor, allyldichlorosilane was converted quantitatively to allyldiethoxysilane and allyltrichlorosilane similarly to allyltriethoxy-silane. The insolubility of poly(vinylpyridine) enabled easy recovery of the reaction products. Thus, the crude allyltrichlorosilane product containing ADCS, ATCS and DADCS can be ethoxylated in the presence of 1-methylimidazole to yield allyltriethoxysilane (bpt 147° C.) and diallyldiethoxysilane (bpt 189.5° C.). The same crude product, when ethoxylated in the presence of poly(vinylpyridine) as HCl acceptor, yields allyldiethoxysilane (bpt 108° C.), allyltriethoxysilane (bpt 147° C.) and diallyldiethoxysilane (bpt 189.5° C.), which can be recovered individually by distillation.

Silicon, Spent Contact Mass, Cyclone Fines and Ultrafines

The silicon metal reactant used in preferred embodiments of the process in accordance with the invention can be any commercially available grade of silicon in particulate form. It may be produced by any of the methods in current practice, such as casting, water granulation, atomization and acid leaching. These methods are more fully described in Silicon for the Chemical Industry, (H. Oye, et al, Editors), vol 1 (pp 39-52), vol II (pp 55-80), vol. III (pp 33-56, 87-94), Tapir Publishers, Norwegian Institute of Technology, and in U.S. Pat. Nos. 5,258,053; 5,015,751; 5,094,832; 5,128,116; and 4,539,194.

Special types of chemical grade silicon containing controlled levels of promoters and alloying elements are also suitable, provided that copper is not one of the alloying clements. Special silicon of this type is described in U.S. Pat. Nos. 5,059,43; 5,714,131; 5,334,738; 5,605,583; 5,973,177; 6,057,467 and European Patents 0,494,837 and 0,893,448. A typical composition of commercial, chemical grade silicon metal useful in this accordance with the invention expressed in percent by weight, is Si˜98.5%, Fe˜0.1 to 0.7%, Al˜0.05 to 0.7%, Ca˜0.001 to 0.3%; Pb<0.001%, Water<0.1%. Generally, smaller particle sizes are preferred for case of dispersion in the slurry, faster reaction and minimization of erosion in the reactor. Preferably, there are no particles larger than 500 micrometers so that reactor erosion is minimized. A particle size distribution, wherein at least 90 weight percent of the silicon is between 1-300 micrometers is preferred. Especially preferred is a distribution in which at least 90 weight percent of the silicon particles is between 1-100 micrometers. This includes the dust from silicon grinding operations.

During the Direct Synthesis of methylchlorosilanes and phenylchlorosilanes, particularly fluidized bed Direct Synthesis, silicon is generally depleted steadily from the contact mass, and converted into volatile organochlorosilane products. Even with the batchwise or continuous addition of additional silicon, copper catalyst, and promoters, a point will be reached at which yield and selectivity to the desired products can no longer be sustained economically. Solid residue will typically be left in the reactor at the end of the process. This residue is referred to as spent contact mass or spent mass. It generally comprises unreacted silicon, unreacted copper-activated silicon, copper, copper chlorides and chlorides (c.g., AlCl₃, TiCl₄, FeCl₃) of metals originally present in the silicon, chlorides of the promoter clements (e.g., Zn, Sn, P, Bi) and carbon. Relative to the fresh contact mass, its particle size distribution is depleted in particles less than about 75 microns.

Elutriated solids, which are trapped by the cyclone or filters, are called cyclone fines or cyclone solids. Cyclone solids are usually maximally less than about 50 microns and ninety percent of the particles are between 1.0 and 20 microns. Silicon content should be approximately 40-80 weight percent and the contents of Cu, Al, Fe, Sn, Zn, P, C and other elements are enriched compared to fresh or spent contact mass. For example, copper content is commonly 2 weight percent in spent mass and 10 weight percent in cyclone solids. Aluminum is commonly about 1 weight percent in spent mass and about 2 weight percent in cyclone solids. Iron is commonly about 1.5 weight percent in spent mass and about 3 percent in cyclone solids. Tin, zinc and phosphorus can be 5-50 times more concentrated in cyclone solids than in spent mass.

The particulates that escape the cyclones and collect in the settler are referred to as ultrafines, settler solids or revaporizer solids. Their particle size generally ranges from about 0.1 to 5 microns. Silicon content should be about 40-60 weight percent, copper about 10-20 weight percent and Al, Fe, Sn, Zn, C and P are usually more concentrated than they are in the cyclone fines and spent mass. While spent mass and cyclone fines are dry solids, which can be pyrophoric, ultrafines are wet with organohalosilanes and agglomerate into a sludge. For this reason, ultrafines are sometimes called sludge.

Sludge can be filtered, centrifuged or dried to separate solids from the liquid. The liquid will typically comprise organohalosilane monomers, organohalodisilanes, organosiloxanes and hydrocarbons. Fractional distillation of the liquid allows recovery of the individual monomers and a disilane fraction, which can be cleaved into monomers by conventional means, as well as by the enhanced methods disclosed in U.S. Pat. Nos. 8,637,895 and 8,697,901. The solids content of the sludge is advantageously less than 65 weight percent and preferably 20-60 weight percent to facilitate agitation and flow. Sludge can be dried thermally, with or without vacuum, to produce a free flowing powder for use in the present invention. Alternatively, the sludge is added to the reaction solvent, in an amount that permits facile agitation of the resulting slurry, and the organohalosilane monomers, organohalodisilanes, organosiloxanes and hydrocarbons volatilized with heat and inert gas stripping prior to the introduction of the organohalide reactant.

Processes in accordance with embodiments of the invention can use fresh silicon, grinding dust, spent contact mass, cyclone fines, ultrafines and mixtures thereof, to effect the Direct Synthesis of alkenylhalosilanes. It has been found that product composition can be advantageously controlled by choice of silicon source. Consequently, the product composition can be controlled by combining fresh silicon and cyclone fines in appropriate proportions.

### Alkenylhalides—R¹X

The general formula, R¹X, represents the alkenylhalide used to react with the copper-activated silicon of the present invention. R¹ is an unsaturated aliphatic or cycloalkenyl hydrocarbon radical and X is a halogen atom. Examples of R¹ are groups such as vinyl, allyl, methallyl and cyclohexenyl. Suitable examples of alkenylhalides are vinyl chloride, allyl chloride, allyl bromide, methallyl chloride and cyclohexenyl chloride. Allyl chloride and cyclohexenyl chloride are the preferred organohalides.

Allyl chloride preferably has greater than ninety-eight percent purity. It is advantageously vaporized at a temperature less than that which initiates its thermal decomposition and polymerization. It can be mixed with hydrogen chloride, methyltrichlorosilane or dimethyldichlorosilane and vaporized at 80-100° C. for injection into the reaction slurry.

### Reaction Solvent

Solvents for the Direct Synthesis in accordance with embodiments of the invention should maintain the particulate solids in a well-dispersed state and facilitate mass transfer of the alkenylhalide to catalytic sites on the copper-activated silicon. The ideal solvents useful in the process of this invention are thermally stable compounds or mixtures that do not degrade under the activation and reaction conditions. Structurally, they are advantageously linear and branched paraffins, and naphthenes. One class of preferred paraffinic solvents is the high temperature stable organic solvents typically used as heat transfer media. Examples include aliphatic heat transfer fluids such as Calflo™ AF, Calflo™ LT and Calflo™ HTF, available from Petro Canada.

Naphthenes are cycloparaffins. They are components of white mineral oils, petroleum distillates and some fuels. White mineral oils and petroleum distillates also contain normal and branched paraffins (see A. Debska-Chwaja, ct al., Soap, Cosmetics and Chemical Specialties, (November 1994), pp 48-52; ibid., (March 1995) pp 64-70). Suitable examples of commercial products containing naphthenes and paraffins and useful as reaction solvents for this invention are the white mineral oils, CARNATION 70, KAYDOL and the petroleum distillates sold by Sonneborn, Inc. Other examples of naphthenes useful as reaction solvents are decahydronaphthalene, perhydroanthracene, perhydrophenanthrene, perhydrofluorene and their alkylated derivatives, perhydroterphenyl, perhydrobinaphthyl and their alkylated derivatives.

CALFLO™ Heat Transfer Fluids sold by Petro-Canada are paraffinic materials that are thermally stable up to about 250-330° C. Suitable examples are CALFLO™ LT, CALFLO™ AF and CALFLO™ HTF. Squalane is another paraffinic solvent suitable for the instant slurry-phase Direct Synthesis process. Its unsaturated derivative, squalene, is also an effective solvent. Direct Syntheses with the paraffin and olefinic solvents are desirably conducted at temperatures less than 330° C. Mixtures of naphthenes and normal and branched paraffins are also useful as reaction solvents for the instant invention.

It is desirable that all solvents be free of components with normal boiling points less than 200° C. and, in particular, compounds which have normal boiling points that overlap with those of the alkenylhalosilanes to be produced. It is also advantageous for the practice of this invention that the solvent does not degrade into lower molecular weight compounds when it is heated alone, or in contact with the silicon, copper-activated silicon, cyclone fines, ultrafines and sludge at temperatures up to about 350° C. and pressures up to about 10 bar. Product analysis, distillation and refining can be complicated by lower molecular weight hydrocarbons and other compounds with normal boiling points which overlap those of the alkenylhalosilanes. It is desirable that formation of these impurities be avoided or prevented.

Used solvents can be treated for removal of solids, metal salts, polymeric byproducts and other accumulated impurities, prior to recycle and reuse in the slurry reactor. Remediation comprises filtration of solids and stripping of the filtrate at temperatures up to about 250° C. (atmospheric pressure) to remove lower boiling hydrocarbons and distillable silicon-containing byproducts. Alternatively, the solvent can be recovered by distillation in vacuo to separate it from the copper-laden solids destined for copper recovery.

Silicon, copper-activated silicon, cyclone fines, ultrafines, spent mass and mixtures thereof, can be added together with the solvent in the reactor in any order. The solvent should be present in an amount sufficient to disperse the solid and gaseous reactants homogeneously. Generally, reactions are initiated with solvent and solids in a gravimetric ratio from about 1:2 to about 6:1, preferably from about 2:1 to about 5:1. However, as the silicon is consumed during batchwise Direct Synthesis, the solvent to solids ratio will increase. The ratio can be maintained within narrow limits of the preferred range for continuous reactions.

### Additives

It has been determined that the presence of Lewis acids such as AlCl₃, TiCl₄ and FeCl3 and of free copper in cyclone fines, ultrafines and spent mass can undesirably contribute to alkenyl halide cracking and/or polymerization, solvent transformation and other side reactions, which either do not produce the desired alkenylhalosilanes, or facilitate polymerization of the alkenylhalosilanes once they are formed. These undesirable reactions can be inhibited or controlled by the use of selected additives. Among other mechanisms, these additives can coordinate or react with the Lewis acids or adsorb on free copper surfaces. These additives have been found to exhibit Lewis base properties.

Bases, such as amines, that bond to the copper residues are generally not the most desirable polymerization inhibiting additives. In general, the “hard” Lewis acids tend to include smaller molecules, such as various chlorides. Thus, the “soft” Lewis bases tend to be most effective as polymerization inhibitors, in accordance with the invention. Those of ordinary skill in the art will be able to determine which additives exhibiting Lewis base properties, in addition to those identified below, will effectively inhibit said undesirable polymerization, without undue experimentation.

The Lewis acids and free copper referred to include both what are present in the initial cyclone fines, ultrafines and spent mass feed materials and what are generated as a result of the Direct Synthesis with alkenyl halides in the reaction slurry. The additives should be selected to not inhibit the Direct Synthesis, and/or not induce unwanted chemical reactions in the alkenylhalosilanes being produced. However, as will be shown by example hereinbelow, not all of the additives are equally effective at inhibiting the polymerization of alkenylhalosilanes. For example, dibutylsulfide, thiourea and tetramethylurea are more effective at inhibiting polymerization of allyltrichlorosilane than allyldichlorosilane.

Sulfur-containing additives with —SH functional groups (thiols or mercaptans), —CH₂—S—CH₂- (thioether), —S—S— (disulfide), >C═S (thioketone), (>N)₂C═S (thioamides and thioimidazoles), effectively inhibit the polymerization of alkenylhalosilanes in experiments as well as during the Direct Synthesis. Cyclic sulfur-containing compounds such as thiophene, phenothiazines, thiomorpholine, 1,4-thioxane have also been found to be effective inhibitors of the polymerization of alkenylhalosilanes and the polymerization which occurs during the Direct Synthesis of alkenylhalosilanes. It is advantageous that the additives are resistant to decomposition during the Direct Synthesis and that they have boiling or sublimation points that are higher than the temperatures at which the Direct Synthesis is conducted.

Mercaptan additives of this invention have the general formula, RSH and HS(Q)SH, in which R is a straight or branched aliphatic group, an aryl group, an alkaryl group or a cycloaliphatic group. Q is a group bridging between sulfur atoms in thiols having more than one sulfur atom. Thus, Q can be a straight-chained or branched alkylene group having from two to twenty carbon atoms. Q can also be an oxyalkylene group, a phenylene or cycloaliphatic group. Examples of Q are —(CH₂)ₙ-, (n=1-8) and —(CH₂)ₙ—O(CH₂CH₂O)ₓ—CH₂CH₂-, n=1-4, x =1-8.

Aliphatic examples of R include C8-C20 alkyl radicals such as octyl, dodecyl and octadecyl. Suitable mercaptan additives are C₁₀H₂₁SH, C₆H₁₃C(CH₃)₂SH (tert-nonyl mercaptan), p-heptylbenzylmercaptan, furfuryl mercaptan and grapefruit mercaptan (1-p-menthene-8-thiol). 1,5-Pentanedithiol, HS(CH₂)₅SH, 1,9-Nonanedithiol, HS(CH₂)₉SH and 2,2′-(Ethylenedioxy)dicthanethiol, HSCH₂CH₂OCH₂CH₂OCH₂CH₂SH, are examples of HS(Q)SH.

Effective quantities of a mercaptan or mixture of mercaptans used should be at least sufficient stoichiometrically to bond with and deactivate the Lewis acids initially present and/or generated during the Direct Synthesis. An amount can be added at the outset of the reaction and additional amounts introduced periodically or continuously. When cyclone fines and/or spent mass are the silicon sources for the Direct Synthesis, initial use levels of the mercaptans can be determined from the aluminum content of the cyclone fines and spent mass. The stoichiometric ratio, (SH/Al), can be 0.05-15, preferably 2-5, at the outset of a reaction or at any time during the reaction. With fresh, chemical grade silicon, lower values of the ratio may be used initially and increased values with subsequent silicon charges. Higher ratios provide for inhibition of polymerization induced by Lewis acids other than AlX₃.

Thiophene, phenothiazines, thiomorpholine, and 1,4-thioxane are examples of heterocyclic sulfur-containing additives, which are effective inhibitors of alkenylhalosilane polymerization.

Dodecyl methyl sulfide, CH₃(CH₂)ₙSCH₃ and Ethyldithioacetate, CH₃CSSCH₂CH₃, are representative of thioether and thioester additives, respectively, which are effective inhibitors of alkenylhalosilane polymerization.

Urea, tetraalkylureas, thiourea and tetraalkylthioureas are another class of additives that are effective at inhibiting the polymerization of alkenylhalosilanes, including polymerization of alkenylhalosilanes, which are produced during the Direct Synthesis. These additives can be used alone, or in combination with the above sulfur containing additives.

Effective use levels of all additives are advantageously greater than or equal to the molar concentrations of the Lewis Acids in the reaction mixture. Nonetheless, their inhibiting effect on alkenylhalosilane polymerization is observable at lower concentrations. In all cases, the additives should be charged initially and are preferably dosed continuously or intermittently, thereafter, during the course of the reaction. The initial charge and subsequent dosage should be effective to afford stable selectivity to the desired silanes (allyltrichlorosilane and allyldichlorosilane when the organohalide is allyl chloride) and forestall solvent decomposition.

### Reaction Conditions

Designs, descriptions and operational considerations pertinent to three-phase reactors (for example, agitated slurry reactors, bubble columns, trickle beds) are contained in the following monograph, articles and patents, all of which are incorporated by reference herein:
A. Ramachandran and R. V. Chaudhari, Three Phase Catalytic Reactors, Gordon and Breach Science Publishers, NY, 1983.
N. Gartsman, et al., International Chemical Engineering, vol. 17 (1977) pp 697-702
H. Ying, et al., Industrial & Engineering Chemistry, Process Design & Development, vol. 19 (1980) pp 635-638
N. Satterfield, et al., Chemical Engineering Science, vol. 35 (1980) pp 195-202
M. Boxall, et al., Journal of Metals, (August 1984) pp 58-61
W. Roeckel, C. Scaccia and J. Conti, U.S. Pat. No. 4,328,175 (May 4, 1982)
L. M. Litz, U.S. Pat. No. 4,454,077 (Jun. 12, 1984)

Reactors may be operated in a batchwise or continuous mode. In batchwise operation, a single addition of silicon and copper catalyst precursor, optionally containing cyclone fines, ultrafines or spent mass, individually or admixed with each other, should be made to the reactor at the outset and the alkenylhalide vapor is added continuously, or intermittently, until the silicon is fully reacted, or reacted to a desired degree of conversion. In continuous operation, cyclone fines, ultrafines and/or spent mass, and optionally additives, are added to the reactor initially and thereafter to maintain the solids content and composition of the slurry within desired limits.

In its preferred form, in accordance with the present invention, the Direct Synthesis of alkenylhalosilanes from copper-activated silicon is conducted in a continuously agitated slurry reactor containing solvent, silicon and copper catalyst precursor, optionally cylone fines, ultrafines or spent mass, individually or admixed with each other, tetramethylurea and/or sulfur-containing additives and foam control agents in contact with gaseous alkenylhalide. The reactor may have a single nozzle or multiple nozzles for the introduction of gas. Means of continuous or intermittent addition of silicon, copper catalyst precursor, cyclone fines, ultrafines or spent mass, and polymerization-inhibiting additives are also provided. Means for continuous removal and recovery of the volatile alkenylhalosilane reaction products and unreacted alkenylhalide are also desirably provided. Separation and purification of the alkenylhalosilane products are optimally performed by continuous fractional distillation.

The reaction is generally conducted at temperatures above about 180° C., but below such a temperature as would degrade or decompose the reactants, solvents or desired products. Preferably, reaction of allyl chloride with copper-activated silicon is conducted at a temperature below about 300° C., more preferably in a range from about 200° C. to about 280° C. The pressure at which the reaction is conducted can be varied from subatmospheric to superatmospheric. Atmospheric pressure and pressures up to about 10 atmospheres are generally employed. The preferred range is 1 to 5 atmospheres. Reaction times ranges from 0.1 to 100 hours.

Preferably, the contents of the reaction mixture are agitated to maintain a well-mixed slurry of the copper-activated silicon, polymerization-inhibiting additives, foam control agents and gaseous alkenylhalide in the solvent. Agitation speed and power input must be sufficient to enable effective mass transfer of reactants to the surfaces of the copper-activated silicon, as well as to keep the largest particles suspended in the solvent, and not settled on the bottom of the reactor. Power input is usually calculated as power to volume ratio. Those with skill in the art will be familiar with the relevant equations.

The exit line carrying the reaction mixture from the reactor is preferably well insulated to insure that the alkenylhalosilanes remain gaseous. Solvent vapors and droplets present in the gas stream can be removed by cooling to temperatures that enable their condensation and return to the reactor, while keeping the alkenylhalosilanes vaporized, and/or by passing the reaction mixture through a demister. Volatile metal salts such as AlCl₃, FeCl₂, SnCl₂, TiCl₄, ZnCl₂ and mixed metal salts (for example, CuAlCl₄) that escape the slurry can also be removed thereby.

The presence of gaseous alkenylhalide, alkenylhalosilanes and other gases in the reactor can occasionally lead to foaming. This is undesirable, since it can result in loss of solvent and solids from the reactor. U.S. Pat. No. 5,783,720 (1998) discloses that the addition of foam control agents, preferably silicon-containing foam control agents such as the Momentive products, SAG® 1000, SAG® 100, SAG® 47, and FF170 and Dow Corning FS 1265, will negate or control foaming in the slurry phase Direct Synthesis of trialkoxysilanes. They are also effective foam control agents in the process of the instant invention. SAG® 1000, SAG® 100 and SAG® 47 are compositions comprising polydimethylsilicones and silica. FS 1265 and FF170 contain fluorinated silicones, for example, poly(dimethylsiloxane-co-trifluoropropyl-methylsiloxanes). The foam control agent is preferably durable such that a single addition at the outset of a batch reaction is sufficient to avoid or mitigate foam formation until all of the silicon has been consumed. Effective use levels of foam control agents span 0.000001-5 weight percent based on the total initial weight of the reaction slurry. Higher levels can occasionally lead to reduced reaction rates. Physical and mechanical methods of preventing or controlling foam formation can also be employed. These include rakes, ultrasonic devices, and foam arrestors.

### EXAMPLES

The following Examples are presented to illustrate preferred embodiments of the instant invention. They are not intended to limit the scope of the invention. Rather, they are presented to illustrate the scope and content of the invention.

### Abbreviations and Units Used

| ABBRE- | | ABBRE- | |
|---|---|---|---|
| VIATION | MEANING | VIATION | MEANING |
| g | Gram | DADCS | (H₂C═CHCH₂)₂SiCl₂ |
| kg | Kilogram | ATCS | H₂C═CHCH₂SiCl₃ |
| cm | Centimeter | ADCS | H₂C═CHCH₂SiHCl₂ |
| m²/g | square meters per | DACS | (H₂C═CHCH₂)₂SiHCl |
| | gram | | |
| h | Hour | TC | HSiCl₃ |
| nm | Nanometer | AC | H₂C═CHCH₂Cl |
| μ | Micrometer | | |
| cSt | Centistokes | | |
| wt % | weight percent | | |
| % Si/h | weight percent | ppm | parts per million |
| | silicon converted | | |
| | per hour | | |

Reaction products and unreacted alkenylhalide exited the reactor through a foam arrestor and a 40 cm long×2.5 cm diameter Vigreux column controlled at 140-160° C. when allyl chloride was the alkenylhalide. This served as an entrainment separator for solvent droplets and metal salts. The gaseous reaction mixture was then admitted to a condenser, cooled to ˜0° C. with chilled silicone oil, before it was collected in a sampling flask attached to a dry ice-isopropanol cold finger (−65° C.). Gas leaving the collection flask was cooled by a second dry ice-isopropanol cold finger (−65° C.) before being vented to the hood through a vapor lock bubbler. Liquid collected in this second or final trap was retrieved at the end of the experiment, weighed and analyzed and the data were used in the calculation of total silicon conversion. The bubbler contained silicone oil and had an extra opening for the release of overpressure.

Samples were collected in weighed flat-bottomed flasks and were analyzed by gas chromatography. Gas chromatographic analysis of the reaction product was performed on a HP 5890E chromatograph. The column was 10 ft×¼ inch i.d. packed with 30 wt % OV-210 on acid washed Chrom P. Programs, flow rates and other conditions were appropriate for the samples analyzed.

Gas chromatographic thermal conductivity Response Factors for allyl chloride and allylchlorosilanes were determined experimentally using mixtures in dodecane. Values were in good agreement with those calculated from chemometric parameters (see A. E. Smith (Editor), The Analytical Chemistry of Silicones, pp 282-284). Quantitative analysis had a ±2% error.

Gas Chromatography/Mass Spectrometry (GC/MS) analyses were carried out with an Agilent 6890GC/5973 MSD instrument fitted with a 30 meter-long ZB5 (5% phenyl, 95% methylpolysiloxane) capillary column. Column inner diameter was 0.25 mm and film thickness was 2.5 μm. The carrier gas was helium with 200:1 injection split ratio. The injection port and GC/MS interface temperatures were 250° C. and 270° C., respectively. Injection volume was 1 ul. The oven temperature was held at 50° C. for 2 minutes before it was raised at a rate of 8° C./min to 340° C., and then was held for 16 minutes. The mass spectrometer was operated in the EI (70 eV electron impact ionization) full scan (m/z 10-800) mode.

For NMR characterization, samples were analyzed with a Bruker AVANCE 600 Spectrometer operating at field strength of 14.1 T. Protons (1H's) resonate at 600 MHz at this field strength. Samples for ²⁹Si nmr were prepared as a 25% to 30% by volume solution in Cr(AcAc)₃/CDCl₃ to a final Cr salt concentration of ˜0.05M Cr(AcAc)₃. The solution was placed in a 10 mm NMR tube. Chemical shifts were externally referenced to tetramethylsilane (TMS). An inverse gated decoupling pulse sequence was used with a pulse width of 45-degrees For 29Si. A delay of 10 s was used between scans (AQ of 1.4 s). The data were processed using a LB of 2 Hz.

### Materials Used for Illustrative Examples

Cyclone fines and ultrafines (sludge) were obtained from commercial production of methylchlorosilanes. Cyclone fines were 1-10 microns in size with a mean of 5 microns. The composition is summarized in Table 1. Fresh silicon with average particle size 30 μm and elemental composition Fe=0.31%, Al=0.27%, Ti=0.033%, Ca=0.021%, P=0.0045% was used in some experiments.

Solvents used included Calflo™ AF and Calflo™ LT.

TABLE 1
COMPOSITION OF CYCLONE FINES

| | CONCEN- | | CONCEN- |
|---|---|---|---|
| ELEMENT | TRATION | ELEMENT | TRATION |
| Si, wt % | 70-80 | P, ppm | 150-220 |
| Cu, wt % | 8-10 | Ni, ppm | 130-1500 |
| Al, wt % | 1.2-1.5 | Sn, ppm | 50-100 |
| Ca, wt % | 0.45-0.50 | Zn, wt % | 0.5-0.8 |
| Fe, wt % | 3.0-3.5 | | |

Allyl chloride used was a commercial product of 98.5-99.5% purity. Principal impurities comprised 2-chloropropene, 2-chloropropane, 1-chloro-1-propene, and 1,5-hexadiene. In some experiments, allyl chloride was delivered into the top of the reaction slurry by syringe. In others, it was vaporized at 80° C. and introduced at the bottom of the reactor. Mixtures of allyl chloride with methylchlorosilanes or HCl were also used in some experiments.

### Examples 1A-1C (Comparative)

The desirable monomers are volatile and will evaporate from the reaction slurry. The undesirable polymers are heavy and will build up in the vessel. Thus, an increase in weight indicates that undesirable polymerization is occurring. The three experiments of this Example illustrate the increase in weight and volume of the reaction mixture during the slurry-phase Direct Synthesis of allyltrichlorosilane and allyl dichlorosilane from allyl choride-HCl mixtures and cyclone fines in Calflo™ AF. This increase in weight is due to polymerization and side reactions, primarily the formation of diallyldichlorosilane (DADCS), as discussed below. The quantities of materials used and the reaction conditions are summarized in Table 2.

In each experiment, Calflo™ AF and cyclone fines (˜70 wt % Si) were charged to the reactor along with FF-170. The reaction mixture was sparged with 100 mL/min nitrogen, stirred at 500 rpm and heated to 235° C. HCl gas was then introduced to the reactor at 420 ml/min. Allyl chloride was pumped from a reservoir into an evaporator heated at 80° C., and then fed to the reactor as vapor. Actual average reaction temperatures (Table 3) were higher than the set value due to exotherms.

TABLE 2
MATERIALS AND REACTION CONDITIONS
FOR EXAMPLES 1A-1C

| | Example 1A | Example 1B | Example 1C |
|---|---|---|---|
| Calflo AF, g | 703.8 | 702 | 723 |
| Cyclone Fines, g | 202 | 213.8 | 230 |
| FF-170, g | 3.3 | 2.5 | 2.4 |
| Agitation, rpm | 500 | 500 | 500 |
| Allyl Chloride, | 3.6 | 2.3 | 2.4 |
| g/min | | | |
| Temperature, ° C. | 245 | 239 | 240 |
| Reaction Time, h | 3.7 | 4.5 | 5.5 |
| HCl, ml/min | 420 | 420 | 420 |
| Allyl Chloride/HCl, | 2.51 | 1.60 | 1.67 |
| molar ratio | | | |

The gaseous reaction products were condensed and the liquid collected every half hour and later analyzed by gas chromatography. The experiments were terminated after the reaction times shown in Table 2. Table 3 shows total weight of crude product collected and percent silicon conversion calculated based on the weight and composition on the recovered product and the weight of silicon available in the cyclone fines. Table 3 also summarizes the composition of the major silicon-containing products in the crude.

TABLE 3
EXPERIMENTAL DATA FOR EXAMPLES 1A-1C

| | Example 1A | Example 1B | Example 1C |
|---|---|---|---|
| Crude Product, g | 458 | 467.60 | 429.20 |
| ADCS, wt % | 33.20 | 41.46 | 43.92 |
| ATCS, wt % | 47.65 | 41.11 | 43.58 |
| DADCS, wt % | 6.08 | 3.88 | 2.09 |
| Silicon Reacted, g | 60.4 | 75.2 | 70.9 |
| Reactor Weight | 240 | 146 | 214 |
| Increase, g | | | |
| Total Polymer | 300.4 | 221.2 | 284.9 |
| formed, g | | | |
| *Si Conversion, % | 42.67 | 50.13 | 44.02 |
| *Rate, % Si Conv/h | 11.8 | 11.1 | 8.0 |
| §Adjusted Si | 75.66 | 73.16 | 71.47 |
| Conversion, % | | | |

*Calculation based on weight and composition of crude product collected and 70 wt % silicon available in cyclone fines
§Calculation based on the assumption that reactor weight increase due to polymerization of DADCS

It was observed that the slurry had increased in weight during the reaction. This indicated formation of reaction products that were not discharged from the reactor at reaction temperatures shown above, due to polymerization and other side reactions. Polymer formation (300.4 g) was most in Example 1A, which was run with the highest allyl chloride/HCl molar ratio and for the shortest time. It also had the most DADCS and the highest ATCS/ADCS gravimetric ratio (1.44). Based on the references cited above, and the data and observations from Examples 2-5, it was assumed that the weight increase was due to the polymerization of allylchlorosilanes. The adjusted silicon conversion shown in Table 3 was calculated on the assumption that diallyldichlorosilane (DADCS) with 15.50 wt % Si was primarily responsible for the polymer formation.

The rationale for the calculation is the following. Normally, silicon is vaporized from the reactor as allylchlorosilanes and the reactor shows a weight loss. When polymerization occurs, the mass produced must first cancel the decrease due to reacted silicon before an increase is manifested. Thus, the total polymer weight is the sum of silicon reacted and the increase in reactor weight.

### Examples 2A-2C: Polymerization of allyl chloride under Different Conditions (Comparative)

These Examples illustrate that it is the reaction products of allyl chloride with cyclone fines that undergo polymerization, and not allyl chloride itself.

Polymerization of allyl groups via peroxide and metal complex catalysis is well known in the literature (Forbes, et al. Marvel, et al and Butler, et al., supra). Accordingly, a set of experiments, with different conditions, was run in the apparatus described in Example 1, to determine whether the increased mass observed in Examples 1A -1C was due to allyl chloride polymerization. Table 4 lists the different reaction conditions and the corresponding residue weight change.

TABLE 4
MATERIALS AND REACTION CONDITIONS
FOR EXAMPLES 2A-2C

| | ALLYL | | | REACTOR |
|---|---|---|---|---|
| EXAM- | CHLORIDE | CYCLONE | | WEIGHT |
| PLE | FEED | FINES, g | AlCl₃, g | INCREASE, g |
| 2A | Allyl Chloride, | None | None | None |
| | 52 g/30 min | | | |
| 2B | Allyl Chloride, | None | 4.9 | None |
| | 52 g/30 min | | | |
| 2C | Allyl Chloride, | 154.7 | 4.9 | 20 |
| | 52 g/30 min | | | |

At 235° C. (Example 2A), feeding 52 g (0.68 mole) of allyl chloride and 7.44 ml/min HCl (3.32×10⁻⁴ mole/min) into Calflo™ AF for 30 min did not result in a weight increase in the reactor. The addition of 52 g (0.68 mole) allyl chloride over 30 min and 7.44 ml/min HCl (3.32×10⁻⁴ mole/min) to Calflo™ AF in the presence of 4.9 g AlCl₃ (Example 2B), a Lewis Acid that is present in cyclone fines, also did not yield a weight increase. However, when 52 g of allyl chloride (0.68 mole) and 7.44 ml/min HCl (3.32×10⁻⁴ mole/min) were fed in 30 minutes to the reactor containing cyclone fines (154.7 g) and 4.9 g AlCl₃ (Example 2C), 20 g of non-distillable material was formed. These results indicated that the mass generated in the reactor was most likely due to the further reactivity of the allylchlorosilanes, which were formed from the reaction of allyl chloride/HCl and silicon in cyclone fines, rather than the polymerization of allyl chloride itself.

### Examples 3A-3C (Comparative)

Examples 3A-3C illustrate Friedel-Crafts reaction of allylchlorosilanes (Example 3A) with toluene and the undesirable polymerization of allylchlorosilanes (Examples 3B-3C) when they were heated in toluene or dodecane at 70° C. in the presence of AlCl₃. The experiments were done in 50 ml 3-neck round bottomed flasks fitted with a reflux condenser, magnetic stirrer, and thermocouple. The quantities of materials used in the experiments are listed in Table 5.

In Example 3A, a violent, exothermic reaction occurred when the mixture of DADCS in toluene was added to AlCl₃ in the reaction flask. The product was a brown viscous solution. GC/MS of the reaction mixture showed components with mass 272, which corresponds to the isomers of the Friedel-Crafts reaction of DADCS with toluene as depicted in the following reaction.

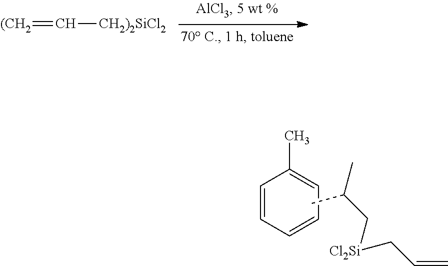

In Example 3B, no reaction was observed when DADCS and dodecane were refluxed at 70° C. for two hours, or stirred with 6.5 wt % AlCl₃ at room temperature for one hour. However, heating DADCS with 6.5 wt % AlCl₃ in dodecane at 70° C. for 1.5 hour produced a brown, insoluble solid. GC analysis of the solution showed that 93 percent of the DADCS had been consumed.

TABLE 5
MATERIALS, REACTION CONDITIONS
AND RESULTS FOR EXAMPLES 3A-3C

| | ALLYL- | | |
|---|---|---|---|
| EXAMPLE | CHLOROSILANE | REACTION CONDITIONS | RESULTS |
| 3A | DADCS, 4.48 g | 2.9 g Toluene, 0.23 g AlCl₃, | Complete conversion |
| | | (5 wt % of DADCS) | to allyl-functionalized |
| | | 70° C./1 h following initial | toluene and insoluble |
| | | exotherm to 100° C. | polymer |
| 3B | DADCS, 2.51 g | 5.76 g Dodecane,, 0.16 g | 93% of DADCS |
| | | AlCl₃, (6.5 wt % of DADCS) | consumed to generate |
| | | 70° C./1.5 h | insoluble polymer |
| 3C | 3.73 g Mixture of 35 | 6.0 g Dodecane, 0.213 g | Total consumption of |
| | wt % ADCS & 65 wt | AlCl₃, (6 wt % of Mixture) | ADCS & ATCS to |
| | % ATCS, | 70° C./1.5 h, | produce insoluble |
| | | | polymer |

In Example 3C, 0.213 g AlCl₃ was added to 3.73 g of a mixture of 65 wt % ATCS and 35 wt % ADCS dissolved in 6.0 g dodecane. No observable reaction occurred after stirring at room temperature for one hour. Heating to 70° C. for 1.5 h produced an insoluble polymer. GC analysis of the liquid showed that all of the ADCS and ATCS had been consumed.

The results of these experiments demonstrate that Lewis Acids like AlCl₃ can undesirably catalyze polymerization of allylchlorosilanes at temperatures that are even lower than those used in the Direct Synthesis reaction. Example 3A illustrates that aromatic solvents (heat transfer fluids) are not recommended for the practice of this invention.

Examples 4A-4E: Control of Allychlorosilane Polymerization with Thiol and Disiloxane Additives

Examples 4A-4E illustrate the effective use of mercaptan and disiloxane additives to inhibit the Lewis Acid-catalyzed polymerization of allylchlorosilanes at temperatures below the Direct Synthesis temperature of allylchlorosilanes. Octadecyl mercaptan (C18H₃₇SH) and hexamethyldisiloxane were the additives used. (See Table 6). Reactions were done at 70° C. for 1.5 hours. Reaction mixtures were then cooled to room temperature and analyzed by gas chromatography.

Example 4A: The experiment of Example 4A was done in a similar manner to that of Example 3B. DADCS, 2.27 g (1.25×10-2 mole), C₁₈H₃₇SH, 0.72 g (2.5×10-3 mole), AlCl₃, 0.227 g (1.70×10-3 mole) and 5.07 g dodecane were mixed and heated to 70° C. and maintained there for 1.5 hours.

Example 4B: The experiment of Example 4B was done with 5.17 g of a mixture of 35 wt % ADCS and 65 wt % ATCS, AICl3, 0.317 g (2.4×10⁻³ mole), C₁₈H₃₇SH, 0.85 g (3.0×10^{31 3} mole), and 6.18 g dodecane at 70° C. for 1.5 hours.

Example 4C: In this experiment, 5.18 g of a mixture of 35 wt % ADCS and 65 wt % ATCS, AIC₃, 0.317 g (2.4×10⁻3 mole), hexamethyldisiloxane, 3.1 g (1.91×10⁻² mole) and 2.7 g dodecane were heated at 70° C. for 1.5 hours.

Gas chromatographic analysis of the reaction mixtures of Examples 4A-4C are presented in Table 6 as the area ratios of the allyl substrates relative to dodecane. Thus, in Example 4A, the ratio of the area of diallyldichlorosilane (DADCS) to the area of dodecane was 0.266 at the start and 0.192 at the end of the experiment. This means that 72.2 percent of the original DADCS was still present in the final reaction mixture. In comparison, 93 percent of DADCS was consumed in the experiment of Example 3B, only 27.8 percent was consumed in Example 4A. The inhibitive effect of octadecyl mercaptan on AlCl₃—catalyzed polymerization of DADCS is thereby indicated.

TABLE 6
REACTION CONDITIONS AND RESULTS FOR THE INHIBITION
OF AlCl₃-INDUCED ALLYLCHLOROSILANE POLYMERIZATION
BY C₁₂H₂₅SH AND [(CH₃)₂Si]₂O AT 70° C./1.5 h

| | ALLYL | | INITIAL AREA | FINAL AREA |
|---|---|---|---|---|
| EXAMPLE | SUBSTRATE | ADDITIVE | RATIO* | RATIO* |
| 4A | DADCS | C₁₈H₃₇SH, 0.72 g | 0.266 | 0.192 |
| 4B | ADCS + ATCS | C₁₈H₃₇SH, 0.85 g | ADCS: 0.150 | ADCS: 0.128 |
| | | | ATCS: 0.282 | ATCS: 0.285 |
| 4C | ADCS + ATCS | [(CH₃)₃Si]₂O, 3.1 g | 1.028 | 1.039 |
| | | | OBSERVATION | |
| 4D | DADCS | [(CH₃)₃Si]₂O, 3.1 g | No Polymerization | |
| | 2.75 g | AlCl₃ 0.496 g | | |
| 4E | ADCS + ATCS | [(CH₃)₃Si]₂O, 2 g + | No Polymerization | |
| | 5.25 g | C₁₈H₃₇SH, 1 g + | | |
| | | 0.35 g AlCl₃ | | |

*GC Area ratio of allylchlorosilane to dodecane

Table 6 presents the individual area ratios for allyldichlorosilane (ADCS) and allyltrichlorosilane (ATCS) obtained in Example 4B. It is clear that the polymerization of ATCS was completely inhibited by octadecyl mercaptan and that 85.6 percent of the original ADCS was still present. So, compared to Example 3C in which both allyl substrates were fully polymerized, only 14.4 percent was consumed and that was exclusively ADCS.

The area ratios in Example 4C are equal within the ±2% error mentioned above for quantitative gas chromatographic analysis. Thus, AlCl₃-catalyzed polymerization of ATCS and ADCS was completely inhibited by hexamethyldisiloxane. Complete inhibition of DADCS polymerization was also observed in a separate experiment with AlCl₃ and hexamethyldisiloxane (Example 4D) as well as with ATCS+ADCS mixture and a combination of octadecyl mercaptan and hexamethyldisiloxane (Example 4E). As shown in the equations below, polymerization was inhibited.

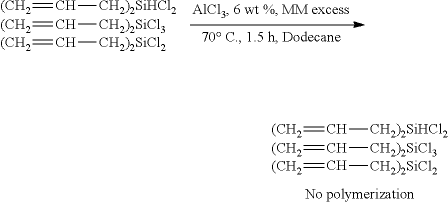

Inhibition of AlCl₃-induced allylchlorosilanes polymerization in the presence of Hexamethyldisiloxane (MM)

### Example 5A-5E: Control OF Allychlorosilane Polymerization with Urea and Thio Additives

These Examples illustrate the effective inhibition of allyl chlorosilane polymerization by tetramethylthiourea [(CH₃)₂NCSN(CH₃)₂], thiourea (H₂NCSNH₂), Tetramethylurea [(CH₃)₂NCON(CH₃)₂] and dibutyl sulfide [(CH₃(CH₂)₃]₂S.

All experiments were conducted simultaneously in the 75 ml reactors of the MRS-5000 combinatorial reactor. The starting material (stock solution) for Examples 5A-5D was prepared from 18.54 g dodecane and 32.86 g of a mixture of 35 wt % ADCS and 65 wt % ATCS. Aliquots of this stock solution were charged to the 75 ml reactors along with AlCl₃ and the appropriate additive indicated in Table 7. The molar ratio of additive to AlCl₃ was approximately 2. Starting material for Example 5E was prepared in nonane due to the co-elution of dibutyl sulfide and dodecane under the gas chromatographic conditions in use. After charging, the reactors were sealed under 1 bar N2 pressure. Reaction mixtures were stirred at room temperature (23° C.) for 1 h and then heated to 70° C. for another hour. After the reactors had been cooled to room temperature, they were opened and the liquid reaction mixture was recovered for analysis by gas chromatography.

Complete polymerization of the ADCS and ATCS occurred in the control Example 5A, wherein no additive was used. Sulfur-containing additives used in Examples 5B, 5C and 5E inhibited the polymerization of ATCS. Loss of ADCS to polymerization was 14-16% at the molar ratio (˜2) of Additive to AlCl₃ employed. That means 84-86 percent was recovered. With tetramethylurea (Example 5D), 79 percent ADCS and all of the ATCS were recovered.

TABLE 7
USE OF TETRAMETHYLTHIOUREA, THIOUREA, TETRAMETHYLUREA
AND DIBUTYL SULFIDE TO FORESTALL POLYMERIZATION
OF ALLYLCHLOROSILANES.

| | STOCK | | | GC ANALYSIS |
|---|---|---|---|---|
| EXAMPLE | SOLUTION, g | AlCl₃, g | ADDITIVE | RESULTS |
| 5A (Control) | 10.53 | 0.454 | NONE | Complete |
| | | 3.40 mmole | | consumption of |
| | | | | ADCS and ATCS |
| 5B | 10.72 | 0.49 | Tetramethylthiourea, | ADCS 15% |
| | | 3.67 mmole | 0.97 g | consumed. No |
| | | | 7.33 mmole | consumption of |
| | | | | ATCS |
| 5C | 8.36 | 0.37 | Thiourea, | ADCS 14% |
| | | 2.77 mmole | 0.43 g | consumed. No |
| | | | 5.65 mmole | consumption of |
| | | | | ATCS |
| 5D | 10.19 | 0.46 | Tetramethylurea, | ADCS 21% |
| | | 3.45 mmole | 0.79 g | consumed. No |
| | | | 6.80 mmole | consumption of |
| | | | | ATCS |
| 5E | 10.89 | 0.66 | Dibutyl Sulfide, | ADCS 16% |
| | | 4.95 mmole | 1.47 g | consumed. No |
| | | | 10 mmole | consumption of |
| | | | | ATCS |

### Examples 6A, 6B

Examples 6A and 6B illustrate the use of hexamethyldisiloxane to improve reaction stability in slurry-phase Direct Synthesis of allyltrichlorosilane and allyl dichlorosilane from allyl choride-HCl mixtures and cyclone fines in Calflo™ AF. The 2 Liter glass reactor was used.

### Example 6A

641.5 g Calflo™ AF and 212.3 g cyclone fines (70 weight percent Si) were charged to the reactor along with 2.0 g FS1265 and 25.7 g hexamethyldisiloxane. Since the fines contained ˜2 wt % Al, the quantity of hexamethyldisiloxane was equimolar with the aluminum. The reaction mixture was sparged with 100 mL/min nitrogen, stirred at 500 rpm and heated to 80° C. and maintained there for one hour. 9.8 g distillate was collected.

Thereafter, the reactor temperature was raised to 235° C., and hydrogen chloride was introduced at the rate of 7.44 mL/min. Allyl chloride was pumped from a reservoir into an evaporator heated at 80° C., and then fed to the reactor as vapor. The experiment was interrupted after 4 hr during which a total of 355 mL allyl chloride had been delivered to the reactor.

The reservoir was recharged with a mixture of 8.8 g hexamethyldisiloxane and 350 g allyl chloride. HCl and allyl chloride flows were then resumed and the reaction was continued at 235° C. for 3 hr.

Overall, 2.45 liters HCl (0.11 mole) and 582.8 g allyl chloride (7.62 mole) were introduced into the reactor. The molar ratio, [Allyl chloride/HCl], was 69.3. The product was collected and analyzed by GC every hour. 603.3 g crude product was collected and 59.98% silicon conversion was obtained from the available silicon in the cyclone fines. Average reaction rate was 8.57 percent silicon conversion per hour based on crude product collected. There was a 120 g increase in the weight of the reactor. Thus, the adjusted silicon conversion was 82 percent.

Table 8 summarizes the composition of the major silicon-containing products in the crude. It is seen that the sum of ATCS and ADCS remained fairly stable up until about 48 percent silicon conversion. The steady-state average was 83.69±2.46 wt %.

TABLE 8
COMPOSITION OF SAMPLES COLLECTED
IN THE EXPERIMENT OF EXAMPLE 6A

| Time, | ADCS, | ATCS, | DADCS, | (ATCS + ADCS) | Si Conv., |
|---|---|---|---|---|---|
| h | wt % | wt % | wt % | wt % | % |
| 1.00 | 48.74 | 35.13 | 2.46 | 83.87 | 6.04 |
| 2.00 | 36.95 | 48.48 | 2.02 | 85.43 | 12.94 |
| 3.00 | 36.02 | 45.66 | 1.86 | 81.68 | 19.93 |
| 4.00 | 39.91 | 41.32 | 2.25 | 81.23 | 26.79 |
| 5.50 | 42.85 | 39.50 | 2.49 | 82.35 | 38.42 |
| 6.50 | 20.12 | 67.47 | 0.91 | 87.69 | 47.49 |
| 7.00 | 5.88 | 66.14 | 0.29 | 72.02 | 51.24 |
| Final Trap | 21.12 | 12.41 | 0.00 | 33.53 | 59.98 |

TABLE 9
CONTROL REACTION

| Time, | ADCS, | ATCS, | DADCS, | (ATCS + ADCS) | Si Conv., |
|---|---|---|---|---|---|
| h | wt % | wt % | wt % | wt % | % |
| 1.00 | 53.29 | 31.19 | 1.60 | 84.39 | 3.85 |
| 2.00 | 38.10 | 43.47 | 1.82 | 81.57 | 10.32 |
| 3.00 | 34.69 | 44.96 | 1.36 | 79.65 | 16.71 |
| 4.00 | 38.66 | 44.46 | 2.07 | 83.12 | 23.80 |
| 5.50 | 40.40 | 41.42 | 1.94 | 81.65 | 34.79 |
| 6.50 | 8.60 | 72.70 | 0.72 | 81.30 | 42.69 |
| 7.00 | 6.43 | 59.86 | 0.75 | 66.29 | 45.74 |
| Final Trap | 19.00 | 12.06 | 0.00 | 31.06 | 55.15 |

Example 6B was run without the addition of hexamethyldisiloxane and was therefore the control reaction against which Example 6A, and other reactions employing additives, is to be compared.

638.6 g CALFLO AF, 212.70 g cyclone fines and 2 g FS 1265 were used in the experiment. Reaction was done at 235° C. and 500 rpm with allyl chloride and HCl as described above in Example 6A. Overall, reaction was continued for 7 hours, during which 545.2 g allyl chloride and 2.54 Liters HCl were fed and 566.6 g crude allyl chlorosilanes were recovered. AC/HCl molar ratio was 63.4. Silicon conversion was 55.2 percent and Average reaction rate was 7.88 percent silicon conversion per hour. The weight of the reactor increased by 110 g. The adjusted silicon conversion was 75.1 percent.

As shown, the use of hexamethyl disiloxane afforded increased silicon conversion (82% vs 75.1%) to the desired allylchlorosilanes. Additional amounts were needed to realize higher reaction rates and stability.

In Example 6B (control), the sum of the concentrations of ADCS and ATCS remained approximately constant (81.95±1.63) from the start of the reaction until about 43 percent silicon conversion. Thus, the use of hexamethyldisiloxane in Example 6A extended the steady-state region by 5 percent and thereby improved the reaction stability. A z-test (see R. Langley, Practical Statistics Explained. Dover Publications, Inc. NY. pp 152-154) was done to determine whether the difference in the steady-state values for (ADCS+ATCS) in Examples 6A and 6B was statistically significant. As is illustrated in the calculation below, the z value is 2.61, which is greater than the threshold value of 2.58 for a chance variation at P=1%. Accordingly, the sum in Example 6A is statistically different from that in Example 6B.

$$\text{?} = \frac{\sqrt{n} \text{?} M = m \text{?}}{S}$$

$$\text{?} \text{indicates text missing or illegible when filed}$$

n=Number of samples (6), M=Average of control group (81.95), m=Average of test group (83.69), S=Standard deviation of control group (1.63)

### Examples 7A,7B and 7C

Examples 7A,7B and 7C illustrate the use of phenothiazine to inhibit the polymerization of allylchlorosilanes during the Direct Reaction of cyclone fines with allyl chloride. Example 6B is the comparative control for these experiments. The quantities of raw materials used and the reaction conditions are set forth in Table 10 and the results are summarized in Table 11.

TABLE 10
REACTION CONDITIONS USED TO ILLUSTRATE BENEFICIAL
EFFECTS OF PHENATHIAZINE IN ALLYLCHLOROSILANE
DIRECT SYNTHESIS WITH CYCLONE SOLIDS

| | EXAM- | EXAM- | EXAM- |
|---|---|---|---|
| | PLE 7A | PLE 7B | PLE 7C |
| CYCLONE FINES, g * | 211.3 (Si = | 209.5 (Si = | 212.1 (Si = |
| | 147.91) | 146.65) | 148.47) |
| CALFLO AF, g | 635.7 | 632.7 | 644.7 |
| FS1265, g | 2.0 | 1.2 | 3.3 |
| PHENOTHIAZINE, g | 0.78 | 2.22 g | 7.92 |
| | | (0-5 h) | |
| | | 1.96 g | |
| | | (5-7.5 h) | |
| ALLYL CHLORIDE, | 575 ml/ | 625 ml/ | 605 ml/ |
| ml/min | 480 min | 450 min | 420 min |
| HCl, ml/min | 7.44 | 7.44 | 7.44 |
| AGITATION RATE, | 500 | 500 | 500 |
| rpm | | | |
| TEMPERATURE, | 235 | 235.2 | 235.4 |
| ° C. | | | |
| DURATION, h | 7.0 | 7.5 | 7.0 |

* Fines contained 70 weight percent silicon

The data show that the use of >0.37 wt % phenothiazine enabled higher silicon conversions to the desired allylchlorosilanes than were realized in the control experiment (Example 6B). Weight increases of the reactor were reduced from 110 g in the control to 52 g and 32 g, respectively, in Examples 7B and 7C. These reductions arose from the inhibition of allylchlorosilane polymerization by phenothiazine. Additionally, average reaction rate increased from 7.88% Si/h in Example 6B to 8.82% Si/h in Example 7B and 9.33% Si/h in Example 7C. The trend towards improved reactivity and stability with increasing use of phenothiazine has therefore been established. Additionally, the data of Example 7B indicate that it is advantageous to add phenothiazine intermittently (or continuously) rather than in a single shot at the start of the reaction.

TABLE 11
DATA ILLUSTRATING BENEFICIAL EFFECTS
OF PHENATHIAZINE ON ALLYLCHLOROSILANE
DIRECT SYNTHESIS WITH CYCLONE SOLIDS

| | EXAM- | EXAM- | EXAM- |
|---|---|---|---|
| | PLE 7A | PLE 7B | PLE 7C |
| PHENOTHIAZINE, wt % | 0.37 | 1.99 | 3.73 |
| based on cyclone fines used | | | |
| TOTAL WEIGHT OF | 541.4 | 687.7 | 660.0 |
| CRUDE, g | | | |
| SILICON REACTED, g | 80.2 | 97.0 | 97.0 |
| REACTOR WEIGHT | 108 | 52 | 32 |
| INCREASE, g | | | |
| ADCS, g | 161.3 | 219.1 | 221.6 |
| ATCS, g | 228.9 | 245.0 | 248.2 |
| SILICON CONVERSION, % | 54.2 | 66.16 | 65.33 |
| AVERAGE RATE, % Si | 7.74 | 8.82 | 9.33 |
| Conv/h | | | |
| ADJUSTED SILICON | 73.8 | 81.89 | 78.80 |
| CONVERSION, % | | | |

### Example 8:

### Direct Synthesis of allyl chlorosilanes with CuCl, Zn, Sn and ˜30 Micron Fresh Si

Example 8 illustrates the slurry-phase Direct Synthesis of allyl chlorosilanes via reaction of allyl chloride with fresh silicon, catalyzed with CuCl and promoted with zinc and tin. 157.5 g silicon (˜30 micron average particle size) was added to 599 g Calflo AF along with 7.63 g CuCl, 0.96 g anhydrous zinc formate, 0.02 g anhydrous tin formate, 1.8 g FS1265. This fine powder silicon is similar to waste silicon powder that can be created during silicon processing. The reaction was conducted for 6 hours at 235° C. with 500 rpm agitation, HCl (7.44 ml/min) and allyl chloride (1.44 ml/min). Total allyl chloride used was 520 ml (488.8 g , 6.39 moles) and total HCl was 2.68 liters (0.119 moles). The molar ratio of allyl chloride to HCl was 53.67.

TABLE 12
SUMMARY OF EXPERIMENTAL DATA FOR DIRECT SYNTHESIS
OF ALLYLCHLOROSILANES WITH FRESH SILICON

| TIME, | ADCS, | ATCS, | DADCS, | (ADCS + | Si |
|---|---|---|---|---|---|
| h | % | % | % | ATCS), % | Conversion, % |
| 1 | 19.34 | 62.34 | 0.18 | 81.68 | 5.14 |
| 2 | 21.40 | 64.97 | 0.27 | 86.37 | 13.14 |
| 3 | 21.54 | 66.12 | 0.37 | 87.66 | 21.41 |
| 4 | 16.30 | 71.28 | 0.44 | 87.58 | 29.95 |
| 5 | 11.73 | 73.48 | 0.38 | 85.21 | 37.00 |
| 6 | 17.27 | 59.39 | 0.27 | 76.66 | 40.19 |
| TRAP | 10.14 | 16.57 | 0.00 | 26.71 | 47.42 |

A total of 617 g crude allyl chlorosilanes was collected. The reactor weight decreased by 73 g. Using the hourly product compositions and sample weights, it was calculated that 74.68 g silicon was converted to allylchlorosilanes. Average reaction rate was 7.90% Si conv/h and (ADCS+ATCS) was 84.19+4.30% during the reaction. Additional data are summarized in Table 12.

### Examples 9A and 9B: Initially Fresh Si with and without Inhibitors (phenothiazine). Second Charge with Cyclone Fines

These Examples illustrate the effect of phenothiazine on the slurry phase Direct Synthesis of allylchlorosilanes from fresh silicon with and without added cyclone fines. Example 9A was run similarly to Example 8, but with addition of 1wt % phenothiazine. Example 9B was a continuation of Example 9A with added cyclone fines and phenothiazine. Aside from the reagents, allyl chloride and HCl, no other materials were added to the experiment of Example 9B.

Average reaction rate in Examples 8, 9A and 9B was 7.90% Si conv/h, 8.17% Si conv/h and 9.05% Si conv/h, respectively. Thus, there was approximately 11 percent increase in reactivity when cyclone solids were added to the reaction initiated with fresh silicon. The reactions with only fresh silicon (Examples 8 and 9A) showed weight losses: 73 g in Example 8 and 82 g in Example 9A. In contrast, Example 9B, with the added cyclone solids, had a weight gain of 20 g. Using the hourly product compositions and sample weights, it was calculated that 77 g silicon was converted to allylchlorosilanes in Example 9A and 62.8 g in Example 9B. So, overall 82.8 g polymer was formed in Example 9B and the adjusted silicon conversion was 49 percent.

Accordingly, additional phenothiazine was required in Example 9B to forestall the polymer formation completely and enhance silicon conversion to allylchlorosilanes.

TABLE 13
REACTION CONDITIONS FOR PHENOTHIAZINE-INFLUENCED
DIRECT SYNTHESIS OF ALLYLCHLOROSILANES FROM
FRESH SILICON WITH (EXAMPLE 9B) AND WITHOUT
(EXAMPLE 9A) CYCLONE SOLIDS

| | EXAMPLE 9A | EXAMPLE 9B |
|---|---|---|
| Silicon | 157.0 | None added |
| Calflo AF, g | 599 | None added |
| Cyclone Fines, g | 0 | 106.0 (74.2 g Si) |
| CuCl, g | 7.63 | None added |
| Zn(OOCH)₂, g | 0.96 | None Added |
| Sn(OOCH)₂, g | 0.02 | None Added |
| FS1265, g | 1.9 | None Added |
| Phenothiazine, g | 1.57 | 1.08 |
| Agitation, rpm | 500 | 500 |
| Allyl Chloride, | 520 ml/360 min (1.44) | 390 ml/270 min (1.44) |
| g/min | | |
| Temperature, ° C. | 235 | 235 |
| Reaction Time, h | 6 | 4.5 |
| HCl, ml/min | 7.44 | 7.44 |
| Allyl Chloride/HCl, | 53.45 | 53.45 |
| molar ratio | | |
| Crude Product, g | 656.9 | 420.3 |

TABLE 14
SUMMARY OF EXPERIMENTAL DATA FOR EXAMPLE 9A

| | SAMPLE | | | | | Si |
|---|---|---|---|---|---|---|
| TIME, | WEIGHT, | | | | (ADCS + | Conversion, |
| h | g | ADCS, % | ATCS, % | DADCS, % | ATCS), % | % |
| 1 | 61.2 | 31.02 | 48.64 | 0.27 | 79.66 | 4.89 |
| 2 | 91.2 | 37.63 | 46.99 | 0.56 | 84.62 | 13.59 |
| 3 | 91.5 | 33.91 | 48.56 | 0.62 | 82.47 | 22.21 |
| 4 | 95.2 | 28.75 | 58.45 | 0.71 | 83.20 | 30.51 |
| 5 | 90.4 | 15.99 | 59.97 | 0.72 | 75.96 | 36.76 |
| 6 | 55.9 | 20.96 | 42.81 | 0.46 | 63.77 | 39.47 |
| TRAP | 171.5 | 10.12 | 9.83 | 0.00 | 19.95 | 49.02 |

TABLE 15
SUMMARY OF EXPERIMENTAL DATA FOR EXAMPLE 9B

| | SAMPLE | | | | | Si |
|---|---|---|---|---|---|---|
| TIME, | WEIGHT, | | | | (ADCS + | Conversion, |
| h | g | ADCS, % | ATCS, % | DADCS, % | ATCS), % | % |
| 1 | 63.70 | 49.01 | 38.35 | 3.14 | 87.36 | 7.01 |
| 2 | 83.50 | 49.81 | 34.96 | 3.26 | 84.77 | 16.24 |
| 3 | 92.10 | 36.78 | 53.60 | 2.05 | 90.38 | 26.16 |
| 4 | 79.70 | 7.92 | 72.82 | 0.65 | 80.74 | 33.09 |
| 4.5 | 22.20 | 8.19 | 51.94 | 1.41 | 60.13 | 34.52 |
| TRAP | 79.10 | 20.56 | 15.04 | 0.12 | 35.60 | 40.71 |

What is claimed is:

1. A process for the synthesis of alkenylhalosilanes, comprising:
(1) forming a slurry of a copper-activated silicon sourced from at least one of fresh silicon, cyclone fines, cyclone fine dust, silicon ultrafines, spent contact mass or mixtures thereof, from the Direct Synthesis of organohalosilanes in a thermally stable solvent;
(2) agitating the slurry;
(3) reacting the agitated slurry with at least one unsaturated aliphatic or unsaturated cycloaliphatic organohalide of the formula R¹X, and optionally at least one organohalosilane or hydrogen halide in the presence of an additive exhibiting Lewis base properties, the additive effective to inhibit polymerization of the alkenylhalosilane, said reaction conducted for a reaction time, a reaction temperature, and a reaction pressure effective to produce the alkenylhalosilanes, said alkenylhalosilanes having the formulae, R¹SiHX₂, R¹₂SiHX, R¹₃SiX, R¹SiX₃, and R¹₂SiX₂ or mixtures thereof, wherein R¹ is an unsaturated aliphatic or cycloalkenyl group, and X is a halogen; and
(4) recovering the alkenylhalosilanes from the slurry.

2. The process of claim 1, wherein R¹ is allyl, vinyl, methallyl, or cyclohexenyl and X is fluorine, chlorine, bromine, or iodine.

3. The process of claim 1, wherein the additive is a sulfur-containing additive selected from the group consisting of polymerization inhibiting thiols and mercaptans, thioethers, thioesters, disulfides, thioketones, thioamides, thioimidazoles and mixtures thereof.

4. The process of claim 1, wherein the additive is a cyclic sulfur-containing additive selected from the group consisting of polymerization inhibiting thiophenes, phenothiazines, thiomorpholine, and 1,4-thioxane and mixtures thereof.

5. The process of claim 1, wherein the additive is selected from the group consisting of urea, tetraalkylurea, thiourea, tetraalkylthiourea and mixtures thereof.

6. The process of claim 1, wherein the additive comprises hexamethyldisiloxane.

7. The process of claim 1, wherein the additive comprises hexamethyldisiloxane and an additive selected from the group consisting of polymerization inhibiting thiols, mercaptans, thioethers, thioesters, disulfides, thioketones, thioamides, thioimidazoles, tetramethyl urea and mixtures thereof.

8. The process of claim 1, wherein the solvent is selected from the group consisting of linear or branched paraffins, naphthenes, and mixtures thereof, having a boiling point greater than 200° C. at standard conditions.

9. The process of claim 1, wherein the solvent is a paraffinic heat transfer fluid.

10. The process of claim 1 wherein R¹ is allyl or methallyl and the organohalosilanes comprise mixtures of R¹SiX₃ and R¹SiHX₂ and wherein the optional hydrogen halide is present and wherein the molar ratio of allyl halide to hydrogen halide in the reagent mixture of step (1) is about 0.8:1 or greater.

11. The process of claim 5, wherein the molar ratio of alkenylhalide to hydrogen halide is about 1 to about 100 or higher.

12. The process of claim 1 wherein additional amounts of additive are added to the slurry during the course of the reaction.

13. The process of claim 1, wherein the molar ratio of the amount of additive added to the slurry during the reaction is based on the additive's molar ratio to all Lewis Acids formed in the slurry during the reaction, said ratio being from about 0.05:1 to about 15:1.

14. The process of claim 1, wherein the ratio of the amount of additive added to the slurry during the reaction is based on the additive's molar ratio to all Lewis Acids formed in the slurry during the reaction, said ratio being from about 2:1 to about 5:1.

15. The process of claim 1 wherein the additive is selected from the group consisting of C₈H₁₇SH, C₁₂H₂₅SH, C₁₈H₃₇SH, C₆H₁₃C(CH₃)2SH (tert-nonyl mercaptan), p-heptylbenzyl-mercaptan, furfuryl mercaptan, grapefruit mercaptan (1-p-menthene-8-thiol), 1,5-Pentanedithiol, HS(CH₂)₅SH, 2,2′-(Ethylenedioxy)-diethanethiol, and HSCH₂CH₂OCH₂CH₂OCH₂CH₂SH, and the thioether is dibutylsulfide, (C₄H₉)2S or dodecyl methyl sulfide, CH₃(CH₂)₁₁SCH₃ and mixtures thereof.

16. The process of claim 1, wherein said reaction temperature is greater than 180° C.

17. The process of claim 1, wherein the alkenylhalide is allyl chloride and the reaction temperature ranges from about 220° C. to about 300° C.

18. The process of claim 1, wherein the reaction pressure ranges from atmospheric pressure to about 10 atmospheres.

19. The process of claim 1, wherein the reaction time is within the range from 0.1 to 100 hours.

20. The process of claim 1, further comprising recovering the solvent from the slurry, and reusing the solvent in a new step (1).

21. The process of claim 1, further comprising, after the initial charge has been partially or fully converted, in a new step (1), introducing additional fresh silicon, fine dust from silicon grinding, cyclone fines, ultrafines and/or spent mass into the reaction slurry and continuing the reaction with the alkenylhalide to produce additional alkenylhalosilanes, without first recovering or remediating the solvent.

22. The process of claim 1. wherein a foam control agent is added to the reaction step.
